(19) United States
(12) Patent Application Publication
(10) Pub. No.: US 2025/0066673 A1
(43) Pub. Date: Feb. 27, 2025

(54) PROCESS TO CONVERT A CARBON CONTAINING MATERIAL IN A HYDRATABLE MOLTEN SALT BATH

(71) Applicant: YERRAWA B.V., HOEVELAKEN (NL)

(72) Inventors: Paul O'CONNOR, HOEVELAKEN (NL); Igor BABIC, HAGENSTEIN (NL); Sjoerd DAAMEN, BOCAIRENT (ES)

(21) Appl. No.: 18/725,220

(22) PCT Filed: Dec. 27, 2022
(86) PCT No.: PCT/EP2022/087898

§ 371 Date: Jun. 28, 2024

(30) Foreign Application Priority Data
Dec. 31, 2021 (EP) 21218502.9

(51) Int. Cl. C10B 49/14; C10B 53/07; C10J 3/57

(52) U.S. Cl. CPC C10B 49/14; C10B 53/07; C10J 3/57; C10J 2300/0946; C10J 2300/1807

(57) ABSTRACT

The invention relates to a process to convert a carbon containing material contained in a waste feed, such as synthetic polymer and/or hydrocarbon, providing effective carbonization to produce carbon and optionally also hydrogen, said process comprising contacting and mixing the carbon containing material with a hydratable molten salt and converting in a carbonisation reactor into a conversion gas and a reaction mixture comprising non-volatile conversion products being solid carbon, collecting conversion gas and adding water or steam to the reaction mixture to re-hydrate the molten salt whereby phase separation occurs forming a non-volatile carbon containing phase and a re-hydrated molten salt phase, separating and de-hydrating the molten salt phase and recycling the dehydrated molten salt and steam back in the process.

### BACKGROUND OF THE INVENTION

### 1. Field of the Invention

The invention relates to a process to convert a carbon containing material, preferably a waste material containing a hydrocarbon, such as a waste oil or refinery residues, and/or a synthetic polymer, preferably a thermoplastic polymer containing waste (TPW). The process produces valuable (re) usable carbon materials.

### 2. Description of the Related Art

In view of the environmental problems caused by plastics and the difficulty to re-use plastics, a lot of R&D effort is spent in converting plastic to fuels, hydrogen, carbon, etc.

US2015/0001061 describes a pyrolysis process for converting plastic to petroleum comprising a pre-melt reactor for melting the plastics, pyrolysis, vaporization, and selective condensation, whereby final in-spec petroleum products are produced.

US2012/0261247 describes a pyrolysis process wherein plastic material is processed to granules or flakes and heated to melt before entering a pyrolysis reactor for pyrolysing the molten material to provide pyrolysis gases; bringing the pyrolysis gases into a contactor having a bank of condenser elements so that some long chain gas components condense on said elements, returning said condensed long-chain material to be further pyrolysed to achieve thermal degradation, and allowing short chain gas components to exit from the contactor in gaseous form; and distilling said pyrolysis gases from the contactor in a distillation column to provide one or more fuel products.

U.S. Pat. No. 7,758,729 describes a waste to fuel (WTF) process comprising a vacuum system to remove vapor from a pyrolytic thermal treatment chamber comprising a series of graduated temperature set points wherein each graduated temperature set point corresponds to a vaporization temperature of an individual by-product of said plastic material, and pulling a vacuum of inert gas on the treatment chamber at each temperature set point to selectively remove an individual by-product corresponding to the temperature set point.

Alamer, A., & Awaji, M. describe in an Undergraduate Thesis with the title “Molten Salt Pyrolysis of Waste Polystyrene”, (2014), Worcester Polytechnic Institute a single pot pyrolysis technique of waste polystyrene by employing eutectic molten salt mixtures to attain high styrene yields at varied conditions. Molten salts provide an excellent heat transfer medium with low viscosity and eutectic molten salts are used here because they have low melting temperature. The process uses helium as inert gas to avoid combustion and process hazard. Alamer et. al. only focusses on the pyrolysis step to study influence of tertiary mixture composition, temperature, etc., on the pyrolysis and does not describe an economic feasible process for recovering hydrogen and carbon from such process.

U.S. Pat. No. 4,104,056 describes a process for the effective use of coal as fuel, comprising alternating hydrogenation and oxidation of coal in molten salt. The process comprising dissolving coal in molten salt, introducing steam under hydrogenation conditions to produce volatile hydrocarbons using a very short residence to prevent pyrolysis followed by adding oxidizing gas to the molten salt comprising dissolved non-volatile residuum under fuel oxidizing conditions to produce heat. The molten salts used herein are eutectic molten salt mixtures, including eutectic mixtures of zinc-chloride with other metal halides.

WO2020/248914 describes pyrolysis of plastic waste by directly heating waste plastics with a high-temperature liquid to undergo thermal cracking reaction in the high-temperature liquid between 200° C. and 500° C. to generate pyrolysis oil (by condensation of pyrolysis gasses in a condenser) and slag. The high temperature liquid is a molten metal or metal alloy in particular lead or lead alloys. Zinc chloride is also mentioned.

CN110538637 describes a method for converting polyethylene terephthalate plastic into a carbonaceous nanostructured material wherein in step a) a salt or salt mixture is used for heating the plastic and then step b) washing and desalting are carried out to obtain the carbonaceous nanostructure material. The obtained carbonaceous nanostructure material is then heated at the temperature of 450° C. to 1300° C. in a protective noble gas atmosphere or in a molten salt medium to obtain the nano-structured carbon material. The salts mentioned include ZnCL₂ at heating temperature 270-450° C.

WO2018141911A describes a process to convert hydrocarbons to hydrogen and a separate carbon phase wherein hydrocarbons, in particular natural gas, are contacted with aa molten salt at very high temperatures above 500° C.

US2014/135510 describes a process for converting polysaccharides, in particular lignocellulosic biomass material, in an inorganic molten salt hydrate to platform chemicals comprising the steps of dissolving, hydrolyzing to monosaccharides, hydrogenating to sugar alcohols and dehydrating to anhydro sugars.

Chambers, et. al. describe an article in Industrial & Engineering Chemistry Process Design And Development, 23 (4), 648-654 with the title: “Polymer waste reclamation by pyrolysis in molten salts” (1984) a process the pyrolysis of a polymer waste feed originating from the reclamation of automobile shredder waste comprising shredded tyres, plastics and other waste materials, using molten salts as pyrolysis media at temperatures between 380 and 570° C. The process involves grinding in liquid nitrogen. The process uses dry nitrogen as inert gas to avoid combustion and process hazard. Therefore the process is expensive and not practical. The resulting product is mostly char, which is a product of low value. Chambers focusses only on the pyrolysis step to study influence of molten salt type, temperature, etc. on the pyrolysis and does not describe an economic feasible process for converting waste material to hydrogen and carbon from such process.

The described processes have one or more of the disadvantages that they require very high energy input, that they can be economically feasible only at an economy of scale requiring huge investments, that they have unacceptable environmental impact, that they achieve a low yield of valuable products formed; in particular a relatively low hydrogen and carbon yield and that also toxins can be formed, such as di-olefins, nitrosamines, polyaromatic compounds, etc. which end up in the gas, liquid or water phase leading to extra costs derived from the treatment of these toxic streams.

The object of the invention is to provide a process to convert a carbon containing material, preferably a waste feed comprising a synthetic polymer and/or a hydrocarbon providing effective carbonization to produce a good yield of hydrogen and carbon in an economically and environmentally attractive process while producing no or minimal CO₂ emissions, thereby resulting in negative overall CO₂ emissions.

### BRIEF SUMMARY OF THE INVENTION

The present invention addresses these problems by providing a process to convert a carbon containing material comprising the following steps:
a. contacting and mixing the carbon containing material with a hydratable molten salt,
b. converting the carbon containing material in the molten salt in a reactor under carbonisation conditions
   i. at a temperature T1 between 200° C. to 500° C., preferably between 200° C. and 400° C., more preferably between 200° C. and 350° C. and
   ii. preferably at a pressure below 50 bar, more preferably below 15 bar, even more preferably below 10 bar, most preferably below 1 bar,
   iii. in absence of oxygen,
   iv, wherein the hydratable molten salt is at least partially de-hydrated,
   v. in presence of steam as inert gas,
   vi. forming a conversion gas and a reaction mixture comprising non-volatile conversion products including carbon in the molten salt,
c. collecting conversion gas from an outlet on the reactor, optionally assisted by purging with steam, optionally cooling the conversion gas to condense the steam and recover dry conversion gas,
d. adding water or steam to the reaction mixture to cool the reaction mixture and re-hydrate the molten salt whereby phase separation occurs forming a non-volatile carbon phase and an at least partially re-hydrated molten salt phase,
e. separating the non-volatile carbon phase from the at least partially re-hydrated molten salt phase,
f. heating the obtained partially re-hydrated molten salt phase to form at least partially de-hydrated molten salt and steam, preferably in step b) or in a separate step,
g. using the at least partially de-hydrated molten salt phase in step a) or b),
h. preferably using the steam obtained in step f) in the process, preferably in step a) for purging oxygen from the reactor and/or in step d) for hydration of the molten salt
i. optionally separating inorganics in a separation step wherein inorganic solids are separated from the molten salt by density difference, preferably after step a) and before step b).

It was found that in the process of the invention the carbon containing material is effectively and efficiently converted to carbon and, depending on the type of carbon containing material, also hydrogen, which are valuable products. The obtained dry conversion gas may comprise H₂ and comprises less than 10 wt %, preferably less than 5 and even more preferably less than 3 wt % hydrocarbons having 2 or more carbon atoms, which sets it apart from pyrolysis processes which after condensation results mainly in higher hydrocarbons (comprising mainly C5-C20 hydrocarbons) that are liquid at room temperature.

An advantage of the process of the invention over other process to convert carbon containing waste material such as pyrolysis or steam cracking is that the process can be carried out at low pressure and relatively low temperatures. Pyrolysis typically is performed at temperatures above 450° C. producing liquid oil and gasses. Steam cracking pyrolysis operates at temperatures above 350° C. and at higher pressures up to 20 bar producing liquid oil and gasses. Hydrothermal Conversion processes operate at temperatures above 300° C. and pressures above 100 bar to produce mainly solid carbon. The process of the invention can operate at significantly lower temperatures, even as low as 200-300° C. and in principle, no over-pressure is needed in the carbonisation reactor in step b) for the carbonisation process in the molten salt. Some over-pressure is preferred only to prevent oxygen to enter the reactor.

The process must be carried out in the absence of oxygen to avoid reaction with the produced hydrogen gas, which reduces the yield of the desired hydrogen gas product, but also for safety reasons. An advantage of the process of the invention is that steam can be used as the inert gas. The steam is generated in the process by dehydrating the molten salt and condensed and re-used. So, there is no need for using another inert gas, which makes the process less complex and less expensive. Preferably, before the conversion step b), the oxygen is purged from the reactor and preferably also from the carbon containing material with steam.

A feature of the invention is that hydratable molten salt is used as the only solvent medium in the process with different degrees of hydration (different water content) in different steps of the process to provide molten salt solvents with different solvent quality. This avoids having to use different solvents that make the process more complex and expensive. The hydratable molten salt and water can be recycled and re-used in the process providing a process with low environmental impact both in terms of emissions and in terms of energy consumption.

The possibility to easily change solvent quality can also be used to adapt solvent quality to different feeds; for example it was found that polymeric material, for example in TPW, is more difficult to carbonize than hydrocarbon material. So, polymeric material is preferably carbonized in molten salt having a very low water content, more preferably in anhydrous molten salt and also at somewhat higher temperatures. Hydrocarbon materials, such as oils, can be carbonized with molten salt having a relatively higher water content and at lower temperatures, which is more economic in energy consumption. This makes the process of the invention very flexible for converting different types of feeds and reduces the need for pre-separation and cleaning steps, which is often too expensive to be cost effective.

A further advantage is that the process is not very sensitive to water in the waste feed, which is a great advantage over prior methods that require drying after washing. Water in the waste feed will hydrate the hydratable molten salt and/or will disappear as steam from the carbonisation reactor which is used in the process. The water content in the hydratable molten salt in step b) can be reduced by addition of anhydrous molten salt.

It was found that the process prevents emission of heteroatom impurity in the waste stream, in particular prevents emission of nitrogen and Sulphur impurities as NOx and SOx gasses which are very bad for the environment and/or require additional gas cleaning steps. In the process of the invention impurities are captured in the produced carbon, which carbon in fact can have additional economic value for certain applications.

The process of the invention also allows to remove heteroatom impurities like halogens in an easy way. Halogens can be in certain plastics additives, such as flame retardants, or in halogenated polymers such as PVC.

In particular it was found that in the process of the invention thermoplastic polymer containing waste feed (TPW) is very efficiently carbonized in molten salt with a low water content, in particular in anhydrous hydratable molten salt (AMS). The inventors found that thermoplastic polymers (hereafter also plastics) cannot easily be converted in hydrated molten salt because when the plastics melt they tend to phase separate from the molten salt before they carbonize with the result that heat transfer is impaired. The TPW can be effectively mixed and dissolved or dispersed in molten salt with a low water content or AMS, providing very good heat transfer efficiency. The metal of the molten salt and optional additional metals dissolved in the molten salt can also provide catalytic effect on the carbonisation conversion.

Another advantage of the process of the invention is that it is relatively easy to separate inorganic contaminants from a carbon containing waste. So, in case the carbon containing feed comprises inorganic material these are preferably removed in an inorganics separation step i) wherein inorganic solids are separated from the molten salt by density difference, preferably after step a) and before carbonisation step b). The hydratable molten salt has a density that is significantly higher than that of the carbon containing material (of about 0.5-1.5 g/cm³) such that the carbon containing material will float on the molten salt separated from the inorganics that have a high density. So the inorganics can be removed relatively easily in the same molten salt solvent medium used in the rest of the process.

The process results in high yield of carbon and optional H₂, with minimal C1-C4, CO and CO₂ production and minimal or no liquid oil and/or tar production. Absence of tar is an important advantage compared to Pyrolysis and/or Gasification processes. Exact numbers will depend on type of feedstock. Also, minimal amounts of toxic by-product are formed, which is also a significant advantage compared to a pyrolysis process, where many small molecules (dioxins etc.) are produced in the oil and water phase. In the process of the invention these materials small molecules are fully converted to carbon and/or absorbed by the carbon formed in the process which acts as an active carbon adsorbent. The process of the invention allows easy and effective separation of the carbon produced by hydrating the molten salt.

### BRIEF DESCRIPTION OF THE DRAWINGS

The features and advantages of the invention will be appreciated upon reference to the following drawings, in which:

FIG. 1 is a schematic drawing of one embodiment of the process of the invention.

FIG. 2 is a further schematic drawing of a continuous process.

FIG. 3 is a schematic drawing of the heat flows in the process of FIG. 2.

### DETAILED DESCRIPTION OF THE INVENTION

The invention relates to a process to convert carbon containing material, preferably carbon containing material in a waste feed, preferably a waste feed comprising a thermoplastic polymer (TPW) and/or a hydrocarbon (HCW). Hereafter, the carbon containing material is also referred to as the feed or waste feed of the process.

In a particularly advantageous embodiment of the invention the carbon containing waste feed is a thermoplastic polymer containing waste (TPW), preferably comprising at least 50, more preferably at least 60 wt. % thermoplastic polymers (TP). The waste stream may comprise next to TP also organic materials different from TP, such as biopolymers like cellulose, hemicellulose or thermoset polymers materials. These organic materials can also be converted in the process of the invention but they can produce undesired side products like char and reduce the yield and purity of the obtained carbon and hydrogen and additional purification steps may be needed. Although thermoplastic polymer are more easily converted the process can also convert crosslinked or vulcanized polymers. An important example of such waste material feed is used tires. However, to maximise the yield of conversion products in the process and to avoid process complications and additional purification steps, the TPW preferably comprises as much as possible of thermoplastic polymers. The cleaner and the more uniform the feed the better. Preferably, the TPW comprises at least 60, 70, 80 or even more preferably at least 90 wt. % TP and preferably less than 40, more preferably less than 30 and even more preferably less than 20 wt. % of thermoset polymers and preferably also comprising less than 20 wt. % other waste feed components.

The TPW used in the present invention typically comprises one or more TP selected from the group consisting of polypropylene, Polyethylene, Polyester, Polyvinylacetate, Polyvinylalcohol, Polyvinylchloride or mixtures, copolymers, blends or composites thereof, preferably TP not comprising heteroatoms O, N or halogen, most preferably polyolefins in view of maximizing yield and purity of the conversion products.

In another embodiment the carbon containing waste feed comprises a hydrocarbon (HCW). Examples of hydrocarbon containing waste feeds are oils, fuels, waxes, residues from oil refineries that are not sufficiently pure to use for its originally intended purpose and for further purification steps are not economically feasible. Evidently, the feed can also comprise both thermoplastic polymer and hydrocarbon waste materials. Examples of hydrocarbon sources are waste fossil fuel residue and tars, tar, pyrolysis oil etc.

It is preferred that raw waste streams are pre-treated to largely remove the non-organic (inorganic) materials such as metals, sand etc. Hydrocarbons need not be removed. Organic materials from bio-sources such as carbohydrates, proteins, cellulose, lignin, sugars etc can be converted in the process but that is not preferred. Firstly, it has value to separate and recycle or re-use them. Further, carbohydrates generate water during carbonisation, which is not a problem but is not preferred in the process. Hence, preferably the waste feed is purified to comprise at least 60 wt % TPW and/or hydrocarbon. If municipal waste is used in the process according to the present invention, it is preferably cleaned from metal parts, sand, glass, etc., and/or dried to remove water. In case the waste feed comprises solids, such as plastics it is preferred to reduce the size as small as practically possible to increase contact with the hydratable molten salt.

The process to convert the feed comprises providing a reactor and the feed and preferably purging oxygen from the reactor and from the feed with steam.

Step a) of the process comprises contacting and mixing the carbon containing material with a hydratable molten salt. The contacting can be done in a separate step or directly in the carbonisation reactor. The contacting is preferably under high shear conditions for efficient contacting, preferably a stirred reactor.

Step b) comprises converting the carbon containing material in the molten salt in a reactor under carbonisation conditions at a temperature T1 between 200° C. and 500° C., preferably between 200° C. and 400° C., more preferably between 200° C. and 350° C. Feeds that are more difficult to carbonize, such as polymer waste material, are preferably carbonized at somewhat higher temperatures. For TPW the temperature preferably is between 220° C. and 450° C., more preferably between 220° C. and 400° C., even more preferably between 220° C. and 350° C. The conversion temperature is low compared to prior art pyrolysis processes, which is a great advantage in reducing energy costs of the process and in reducing complexity. A particular further advantage is that the hydrogen production is enhanced at lower temperatures. Lower temperatures are also preferred in view of energy consumption whereas higher temperatures are preferred in view of yield and speed. The optimum balance can be found by the skilled person in each case depending on the specific composition and end desired products.

In principle, no over-pressure is needed in the carbonisation reactor in step b) for the carbonisation process in the molten salt. Some over-pressure is preferred to prevent oxygen to enter the reactor, but preferably not more than 1-5 bar. The pressure typically is autogenic pressure; i.e. the pressure generated by the water evaporating at carbonisation conditions; not by applying external pressure. The water evaporating during carbonisation is typically removed at the outlet of the carbonisation reactor over a pressure valve. The process works at higher pressures but pressures are preferably not higher than 50 bar for process economic reasons because it would require special equipment that is expensive and not necessary. In view of process economy, the pressure is preferably below 15 bar, more preferably below 10 bar, even more preferably below 8 or 5 bar and most preferably below 1 bar (gauge pressure). The time of applying carbonisation conditions is significantly longer than in pyrolysis processes. The time depends on several factors such as the nature and size of the feed, the type of reactor used, the mixing efficiency etc. The time is chosen at the indicated temperatures sufficiently long to achieve substantially complete conversion (e.g. >90 or 95% of feedstock) to carbon and conversion gas.

At high temperatures, for Zinc-chloride above about 290° C., and at the low pressure used in the process the hydratable molten salt stays substantially anhydrous. Any residual water present in the feed or any water formed during the carbonisation process will, at the low pressure and higher temperature conditions, not hydrate the molten salt but will evaporate as steam which is removed from the reactor. The steam can be used as the inert gas media during the carbonization of organic wastes in a molten salt melt, which makes the process simple and cost effective compared to prior art processes that have to use nitrogen or helium as inert gas. A particular advantage is that steam can be easily and continuously separated from the conversion gasses by condensation for example in heat exchangers and recycled in the process, which presents an environmental and cost advantage.

The process according to the invention step b) produces conversion gas which is collected in step c) from the outlet of the reactor, optionally assisted by purging with steam. The composition of the conversion gas depends on the nature of the carbon containing material. A hydrocarbon will convert to carbon and hydrogen. A carbohydrate will convert to carbon and water and form little or no hydrogen. The conversion gas collected in step c) is cooled to condense the steam to recover water and, depending on the nature of the carbon containing material also a dry conversion gas. The obtained dry conversion gas may comprise H₂ and comprises less than 10 wt %, preferably less than 5 and even more preferably less than 3 wt % hydrocarbons having 2 or more carbon atoms, which sets it apart from pyrolysis processes which after condensation results mainly in higher hydrocarbons (comprising mainly C5-C20 hydrocarbons) that are liquid at room temperature.

Step d) comprises adding water or steam to the reaction mixture comprising the carbon to cool the reaction mixture and to re-hydrate the molten salt whereby phase separation occurs between a phase comprising the non-volatile conversion products including carbon (referred to as NVC or carbon phase) and an at least partially re-hydrated molten salt phase, wherein optionally additionally cooling is done by external cooling means. The low density and hydrophobic carbon phase floats to the surface of the more hydrophilic re-hydrated molten salt (referred to as HMS) where it can be easily removed. The cooling and hydration step d) is not only important to create phase separation but also to avoid self-combustion of the NVC when it is separated and would get in contact with open air in step e).

Step e) comprises separating the NVC phase from the at least partially re-hydrated molten salt phase. The cooling and separation steps d) and e) comprise one or more cooling and separation steps. Preferably, the reaction mixture is cooled and hydrated to a temperature Tl below 200° C., preferably below 150° C. At the lower temperature Tl, the solid or liquid carbon phase is separated from the molten salt. The advantage of the low temperature separation step is the higher yield of separated NVC. A lower temperature is also good to lower the risk of combustion of the carbon when in contact with air; so for safety reasons an even lower temperature, for example below 100° C. is preferred. It is a particular advantage of the use of hydratable molten salt that it is possible to go to low temperatures by lowering the melting temperature of the molten salt by hydrating the anhydrous molten salt to form a molten salt hydrate. The lower temperature combined with the change in solvent quality of the re-hydrated molten salt compared to the dehydrated molten salt makes it relatively easy to separate the solid or liquid carbon phase.

Cooling to low temperature Tl is preferred in view of the yield of NVC. However, cooling to a relatively high temperature Th is preferred in view of energy consumption. In an alternative embodiment, at least part of the reaction mixture is cooled to a temperature Th above 200° C., preferably above 250 or even 300° C., wherein optionally pressure is applied, which pressure is preferably applied with steam. It is an advantage of said high temperature separation step that less cooling requires less energy input at the subsequent dehydrating and reheating step. Further, at higher temperatures, a NVC fraction may be separated having a different composition than the NVC separated after direct cooling to low temperatures Tl below 200° C.

The reaction mixture can be cooled from the carbonisation temperature T1 in one step but can also be cooled in two or more steps; steps meaning temperature intervals. For example, a first cooling step can be done to a relatively high temperature Th followed for example by a waiting time to allow phase separation, a transfer to another reactor, a separation step or a purification step followed by a second further cooling step.

It may be a disadvantage that not all NVC separates from the molten salt at higher temperature Th. Hence, in the case a high temperature Th is used, it is preferably followed by a lower temperature separation step. Optionally, only a part of the reaction mixture is cooled to temperature Th and the remaining part is cooled to Tl.

In a further alternative embodiment two or more subsequent cooling and separation steps are applied at different temperatures, preferably first a step at high temperature Th and then a step at low temperature Tl, wherein two or more different NVC fractions with different compositions are obtained, It is an advantage of this alternative step that two or more different NVC fractions with different compositions could be obtained with higher quality product.

After separation of the NVC phase from the re-hydrated molten salt phase, the obtained at least partially re-hydrated molten salt phase produced in step e) is heated to at least partially de-hydrate the molten salt. This can be done in a separate heating step or directly in the carbonisation step b) under carbonisation conditions or during contacting step a).

Preferably, the heating in step f) is to a temperature T2 above 250° C., preferably above 300° C. However, at too long exposure to high temperatures there is a risk of thermal decomposition of the molten salt with substantial formation of HCl, HClO etc. Therefore, it is preferred in step f) to apply vacuum and use lower temperatures. This can more conveniently be done in a separate heating step. The inventors have found that dehydration of zinc chloride under (deep) vacuum and a relative mild temperature it is possible to dehydrate and concentrate ZnCl₂ close to 100% without forming substantial amount of HCl. Therefore, it is preferred that in step f) the at least partially re-hydrated molten salt is dehydrated by heating and applying vacuum, at pressure below 100 Pa (medium vacuum), more preferably below 0.1 Pa (high vacuum), even more preferably below 0.0001 Pa (ultra-high vacuum), and at a temperature preferably below 175° C., more preferably below 150° C., and above 100° C., preferably above 120° C. and wherein optionally a metal oxide is added before or during heating wherein the metal preferably is the same as the metal of the molten salt. As alternative to or in addition to applying the vacuum and the lower temperatures, the formation of HCl (or HBr) can be reduced by addition of a metal oxide that reacts with HCl or HBr; in case of zinc chloride molten salt Zinc-oxide is preferably added.

A particular advantage is that the solvent in all steps is molten salt with different water contents which only involves addition and removal of water which as steam can be used as the inert purge gas and also can be recycled. Therefore, Step g) comprises using the at least partially de-hydrated molten salt obtained in step f) in step a) or b) and Step h) comprises using the steam obtained in step f) in the process, preferably in purging oxygen from the reactor in step a) and/or in step d) for hydration of the molten salt.

In the process according to the present invention, the hydratable molten salt is a hydratable metal halide salt, wherein the metal preferably is Zinc, Aluminum, Antimony, Manganese, Calcium, Iron or Magnesium or combinations thereof, preferably ZnCl₂, FeCl₃. MgCl₂, MnCl₂. CaCl₂) or their bromine analogues or blends thereof. These compounds are all (re) hydratable meaning that it is possible to change the number of hydrated water molecules in the structure (n in the formula Metal-halide.nH₂O. In view of catalytic properties in the carbonisation process ZnCl₂, FeCl₃ and MnCl₂ are preferred. AlCl₃ is possible but less suitable as it forms a gas already at temperature below 500° C. Most preferably the hydratable molten salt comprises at least 70 wt. %, more preferably at least 80 wt % even more preferably at least 90 wt % and most preferably at least 95 wt % ZnCl₂ with the remainder of the hydratable molten salt preferably being one or more other metal halide salts, preferably MgCl₂, MnCl₂. AlCl₃, SbCl₃ or FeCl₃.

ZnCl₂ is a very suitable medium for carbonization at high temperatures as it has a very low vapor pressure. It is a particular advantage of the process using ZnCl₂ that, when increasing the temperature, there is hardly no increase in pressure. As the pressure is rather low, the investment in equipment is also low. This is favorable compare to other molten salts, such as AlCl₃, which have a much higher vapor pressure. Thus, the pressure is not critical and, for reason of convenience, atmospheric or ambient pressure is preferred during the conversion step b). Higher pressures may be used, but preferably below 10 bar.

In the process according to the present invention, the molten salt in step b) preferably comprises less than 20 wt. % hydrated water relative to the total weight of the molten salt and water, preferably less than 10 wt %, more preferably less than 5 wt. % or even more preferably less than 3 wt. % and most preferably less than 1 wt %, wherein low water content is preferred on one hand for increasing carbonisation conversion power, for example needed for carbonizing polymers, but on the other hand a higher water content is preferred in view of lower energy consumption, in particular in having to remove less water in step f). The re-hydrated molten salt formed in step e) preferably comprises between 10 and 60 wt. % water, more preferably between 15 and 50 wt. % and even more preferably between 15 and 35 wt. % wherein wt % is relative to the total weight of the molten salt and wherein preferably the molten salt is ZnCl₂. The re-hydrated molten salt comprises at least 10, more preferably at least 20, even more preferably at least 25 or 30 wt % more water than the de-hydrated molten salt in step b) to make the change in solvent quality of the molten salt (the wt % is relative to the total weight of the molten salt and water).

In the process according to the invention, a solid carbon source or a precursor thereof is added, preferably in step a), b) and/or d), as a seed to enhance the conversion and/or separation of the carbon phase from the molten salt phase. It is believed that the solid carbon catalyzes the conversion reaction and may nucleate the formation and growth of the carbon phase. Examples of a solid carbon source are charcoal, carbon black, carbon fibers, carbon nano-fibers, etc. A solid source precursor is a compound that in the molten salt is directly converted to a solid carbon source, for example cellulose or lignin.

In a useful embodiment, the conversion gas collected in step c) is further separated into water and dry conversion gas, which may comprise H₂, and minimal C1-C4, CO and CO₂ production. The exact production numbers will depend on type of feedstock. In case H₂ and/or pure carbon production is to be optimized, cellulose is removed beforehand from the TPW. Optionally, sulfur can be captured to avoid formation of H₂S. The water separated in step d) may be used in the hydration step wherein the AMS is converted to HMS or used as steam to purge oxygen from the reactor.

In the process according to the present invention, the molten salt further preferably comprises catalytic amounts of one or more dehydrogenation catalyst metals different from the metal in the molten salt, preferably chosen from the group of Ni, Fe, Zn or Cu, to enhance hydrogen yield in the process, preferably added in the form of a metal-organic complex like metal alkyls, metal-oxides or a metal-chloride complex, and preferably in an amount of less than 10, preferably less than 5 or even less than 3 mole % of said metal relative to the moles of metal in the molten salt, wherein the one or more dehydrogenation catalyst are preferably chosen from the group of FeCl₃, NiCl₂, CuCl₂, Fe₂O₃, NiO and CuO and wherein the one or more dehydrogenation catalyst metals are optionally supported on a solid carbon source or a precursor thereof. The use of a dehydrogenation catalyst is particularly preferred as it allows for the use of relatively low conversion temperatures. Most preferred is using ZnCl₂ molten salt with Ni or Fe metal ions as dehydrogenation catalyst metals. It is particularly preferred to use Fe as active metal enabling a magnetic separation of the active metal catalyst from the carbon source.

Optionally, the one or more dehydrogenation catalyst metals are supported on a solid carbon source or precursor thereof. The solid carbon source or precursor thereof for use as seed during the reaction and/or separation step or as support for the one or more dehydrogenation catalyst metals are same or different compound selected from carbon fiber, lignin, cellulosic fiber, carbon nanofiber or carbon nanotube.

Alternatively, the one or more dehydrogenation catalyst metals may be added to the carbon containing material feed before contacting in the reactor with the hydratable molten salt.

In case the feed comprises significant amounts of heteroatoms such as N, O, S, P or halogens, it is preferred that in the process one or more reactants are added to the molten salt to convert hetero-atom containing impurities formed during conversion step b); in particular to convert one or more of halogens, CO₂, SOₓ or NOₓ. Preferably, the reactant reacts with the impurity to form a precipitate which then can be separated. Preferably the reactant is a metal compound, more preferably metal oxide or metal hydroxide, even more preferably zinc oxide, magnesium oxide, iron oxide or nickel oxide, to react with halogens, CO₂, SOₓ or NOₓ to form one or more of metal-halogenides, metal-carbonates, metal-sulfates, or metal-nitrates. In case the heteroatom is a halogen, for example from a PVC polymer, the halogen gas formed during conversion (e.g. Cl₂) is converted with a metal oxide to a metal halide. This metal halide can be separated or becomes part of the molten salt used in the process and does not need to be separated.

For example, oxygen containing compounds degrade to generate CO₂, which can be captured by metal-oxides to produce metal-carbonates. PVC or halogen-based flame retardants in TPW produce halogens when contacted with the molten salt. These halogens can react with the metal oxides, reducing toxic halogen emissions. In a preferred embodiment the reactant is zinc oxide, which can react with the chlorine formed in the degradation of PVC to produce ZnCl₂, which is the preferred molten salt and can be then used in the process. In case the contaminant heteroatom comprises Br or F, the reactant zinc oxide forms the reaction product ZnBr₂ or ZnF₂ respectively. Bromides can be removed by addition of MgO. In a most preferred embodiment the molten salt used in the process is Zinc-Chloride and in the process to convert halogen containing TPW, in particular halogen containing TP, Zinc-oxide is added as reactant to form Zinc chloride. In the case of sulfur containing compounds, they degrade to produce SOₓ which can be reacted with metal oxide to produce metal-sulfates or react directly to produce metal-sulfides. Zn halogenide can be converted by contacting with NaOH to form Zn(OH)₂ (ZnCl₂+NaOH=Zn(OH)₂+NaCl) which precipitates and can be separated. When the obtained Zinc hydroxide is heated it leads to the formation of zinc oxide, which can be used as reactant in the process.

In an alternative embodiment, in case the waste feed comprises biologic waste material comprising carbohydrates such as cellulose, it is advantageous to first separate and remove the carbohydrates. First of all because this produces another valuable product, but also because carbohydrates are less preferred in the carbonisation process as they produce water. Therefore, in the process according to the invention the at least partially re-hydrated molten salt produced in step d) and separated in step e) is used in a separate step e. 1), preferably before being de-hydrated in step f), for the separation of biological organic waste, preferably a biological organic waste comprising cellulose, hemicellulose and/or lignin, at a temperature below 300° C., preferably below 250° C. The at least partially re-hydrated molten salt produced in step d) and separated in step e) can also be used to separately carbonize the biological organic waste, because this can be more easily carbonized at the lower temperatures and higher water content.

In the process according to the present invention, the NVC phase separated in step e) is washed with water at a temperature below 100° C. to dissolve and remove residue of the molten salt and preferably recycling the wash water to step d).

It is preferred that the energy required in the process for heating and conversion is produced by the combustion of hydrogen produced in the process. An advantage of the process is that the energy obtained from the conversion of TPW would generally be higher than the energy required for the process itself.

It is a particular advantage of the process that the solid carbon phase separated from the molten salt in step e) can produce or can be used to produce valuable higher quality carbon materials. Preferably, the carbon phase can produce or can be used to produce active carbon (i.e. sorbents), soil enhancement compounds, electronic materials, carbon fiber, carbon nano fiber or a carbon nanofiber precursor, graphene or graphene precursor (i.e. materials). The formed products after isolation can also be used as seed in the same process.

The present invention further relates to a process wherein carbon containing feed, preferably a waste feed comprising a synthetic polymer, preferably a thermoplastic polymer containing waste (TPW) and/or a hydrocarbon waste (HCW), wherein carbon containing feed, preferably the TPW, is converted in a continuous process comprising continuously:
1) providing a carbon containing feed and hydratable molten salt and at least partly converting the carbon containing feed in the molten salt in a carbonisation reactor to form conversion gas and carbon,
2) taking the conversion gas from the carbonisation reactor to a condenser to condense steam and separate dry conversion gas and transferring part of the molten salt containing the carbon to a separation reactor,
3) adding water or steam to the molten salt containing the carbon in the separation reactor to cool and re-hydrate the molten salt to form a phase separated non-volatile carbon phase and an at least partially re-hydrated molten salt phase,
4) separating and transferring the at least partially re-hydrated molten salt phase out of the separation reactor,
5) optionally using the at least partially re-hydrated molten salt phase from the separation reactor for the separation or carbonization of biological organic waste and separating the at least partially re-hydrated molten salt after use in this step,
6) transferring the at least partially re-hydrated molten salt to a heating reactor and heating the at least partially re-hydrated molten salt phase to de-hydrate to at least partially de-hydrated molten salt and steam and recycling the at least partially de-hydrated molten salt back to the carbonisation reactor OR transferring the at least partially re-hydrated molten salt directly to the carbonisation reactor and heating the at least partially re-hydrated molten salt phase in the carbonisation reactor to de-hydrate to at least partially de-hydrated molten salt and steam,
7) wherein optionally impurities are removed from the at least partially de-hydrated molten salt or the at least partially re-hydrated molten salt prior to recycling back to the carbonisation reactor,
8) removing the non-volatile carbon phase from the separation reactor continuously or semi-continuously, optionally followed by washing the non-volatile carbon phase with water to remove residue of the molten salt, optionally followed by recycling part of the non-volatile carbon phase, or of solid carbon isolated from the separated non-volatile carbon phase, back to the carbonisation reactor as seed to enhance the conversion and/or separation of the non-volatile carbon,
9) wherein optionally inorganics are separated from a mixture of the carbon containing feed in the molten salt by density difference before carbonisation.

Preferably at least part of the conversion in step b) is carried out in a mixer providing very high shear rates, for example a static mixer.

### Description of Illustrative Embodiments

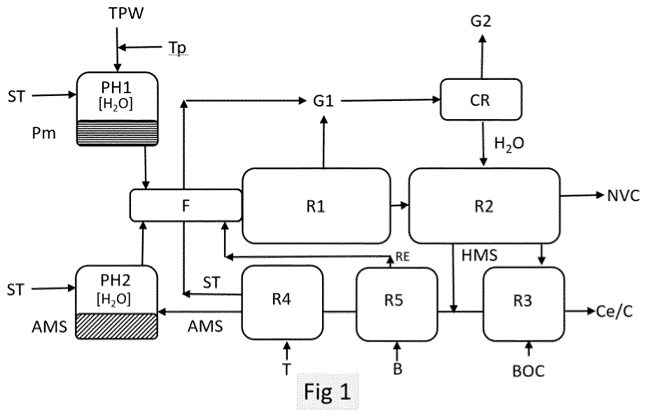

FIG. 1 is a schematic drawing of an embodiment of the process of the invention wherein thermoplastic waste feed TPW is fed to a preheater PH1 wherein oxygen is purged with steam ST and temperature is raised to a temperature Tp to melt the TP in the TPW feed forming polymer melt Pm and the AMS is preheated in preheater PH2 under steam atmosphere ([H₂O]) before feeding to the first reactor R1. In an alternative the TPW and AMS can also be mixed and heated in a different order or fed directly to the reactor R1.

The polymer melt Pm and preheated AMS are mixed and fed via a feed unit F (e.g. an extruder or in-line mixer) to the first reactor R1 where TP is converted to conversion gas G1, which comprises predominantly hydrogen and steam, which is let off at the top. The reaction mixture comprising AMS and the non-volatile conversion products is transferred to separation reactor R2.

In reactor R2 water or steam is added to the reaction mixture to cool the reaction mixture and convert the AMS to hydrated molten salt (HMS) forming a phase separated NVC phase and HMS phase. Preferably, recycled steam or condensed steam is used from gas separator CR wherein steam in gas G1 is condensed to separate water and produce a water free conversion gas G2.

The HMS phase is separated and transferred out of the second reactor R2 for recycling. Optionally, at least part of the HMS phase is transferred from the second reactor R2 to a third reactor R3 for the separation or carbonization of biological organic waste (BOC), for example a cellulose containing waste material, as is known in the art Preferably, in this reaction step cellulose can be dissolved in the HMS, the solution of cellulose in HMS is separated and then cellulose is precipitated e.g. by addition of antisolvent and separated. Alternatively, the BOC can also be carbonized in reactor R3. Also after this step the HMS phase is separated after use for recycling. In this way an waste stream comprising TP and BOC can after separation of the TP and BOC be efficiently converted to useful products.

The NVC phase from the second reactor R2 can be separated continuously or semi-continuously, optionally followed by washing the NVC phase with water to remove residue of the molten salt, optionally followed by recycling part of the NVC phase, or of solid carbon isolated from the separated NVC phase, back to the first reactor as seed to enhance the conversion and/or separation of the NVC (not shown in FIG. 1).

The HMS phase from the R2 and/or R3 is transferred to a fourth reactor R4 wherein the recycled used HMS phase is again converted by heating (T) to AMS and steam after which the AMS is recycled back to the first reactor R1, directly to R1 or indirectly via preheater PH2 and/or feed unit F. The steam generated in R4 can be used to purge in PH1, PH2 or other reactors or be recycled in the gas stream G1 to CR.

Optionally, in a fifth reactor R5 a base B can be added, either to (part of) the recycled HMS phase coming from reactor R2 and/or R3 and/or to (part of) the AMS coming from reactor R4, for converting metal of the molten metal salt to metal oxide which is separated and transferred to R1. The metal-oxide RE acts as reactant RE to capture heteroatom containing impurities formed in reactor R1. In the preferred embodiment wherein the molten salt is Zinc Chloride, in R5 Zinc Oxide is formed as RE. Optionally (not shown in FIG. 1) instead of this optional step or in addition to this optional step in R5 other reactants RE can be separately added to the first reactor R1 for capturing heteroatom containing impurities formed in reactor R1.

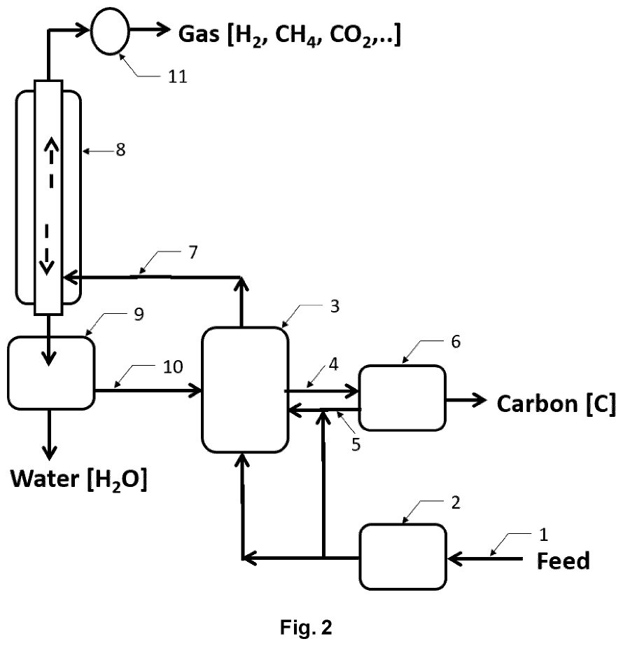

FIG. 2 is a schematic drawing of a practical concrete and simplified embodiment of the process of the invention wherein a hydrocarbon feed is converted to Carbon [C] and conversion gas comprising mainly H₂, CH₄, CO₂ wherein reactors and process steps are indicated showing:
1. A carbon containing feed mixed with molten salt hydrate.
2. Optional pre-treatment removal of inorganics
3. Carbonisation reactor
4. Molten salt containing Carbon phase
5. Regenerated molten salt
6. Carbon separation section
7. Gasses formed by carbonisation (including steam)
8. Condenser to separate water and dry carbonisation gasses; mainly H₂, CH₄, CO₂
9. Water collector
10. Water (or steam) recycle to reactor section
11. Pressure control

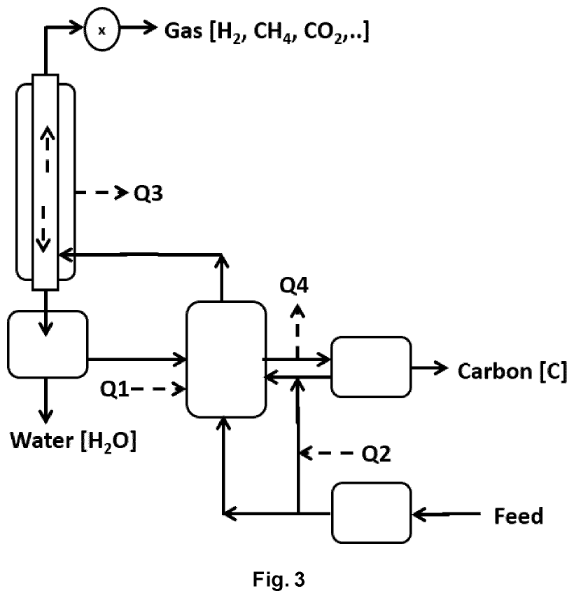

FIG. 3 is a schematic drawing of the same embodiment of the process of FIG. 2 wherein heat flow is indicated wherein: Q1=Heating of reactor, Q2=Heating of feed, Q3=cooling of gas and water condensation and Q4=Cooling of effluent from the carbonisation reactor.

The invention is further illustrated by the experiments described below.

### Experiment 1

Lignin (0.5 gr) was mixed with 16 gr of ZnCl₂ hydrate comprising 70 wt % ZnCl₂ (relative to the total weight of ZnCl₂ and hydrated water) and placed into Hastelloy tubular reactor (16 ml volume). The mixture was stirred continuously during the experiment. The air in the reactor was replaced by nitrogen by alternatingly applying vacuum and pressurizing with nitrogen at 8 Bar for three cycles. The reactor was closed at atmospheric pressure and placed into a heating oven. The temperature of the reactor was increased to 290° C. and the reactor was kept at this temperature for 90 min. The reactor was removed from the oven, cooled down to room T. The gas phase was taken out of the reactor by releasing the pressure build up by the steam and analyzed using Gas chromatography and mass spectrometry. Water was added to separate the carbon phase and wash out the ZnCl₂ The results are listed in Table 1. The H₂ and carbon yield is in weight % relative to the feedstock weight. 0% Liquid hydrocarbons means that after cooling to room temperature at 22° C. no condensed liquid hydrocarbons were observed.

### Experiments 2 to 8

Experiments 2 to 8 were done in the same way as described for example 1 except that the carbon containing material, the carbonisation time and temperatures and the molten salt water content were varied as described in Table 1. Anhydrous ZnCl₂ molten salt comprised no water.

TABLE 1

| | | ZnCl2 | T | Time | H₂ yield | | Liquid |
|---|---|---|---|---|---|---|---|
| Exp. | Feed | molten salt | (° C.) | (min) | (wt %) | Carbon | hydrocarbons |
| 1 | Lignin | Hydrated | 290 | 90 | 2% | >95% | 0% |
| 2 | Lignin | Hydrated | 220 | 30 | ±0.5% | >95% | 0% |
| 3 | Cellulose | Hydrated | 220 | 30 | ±0% | >95% | 0% |
| 4 | Sugars | Hydrated | 200 | 30 | ±0% | >95% | 0% |
| 5 | Poly-Ethylene | Hydrated | 220 | 30 | n.d. | >95% | 0% |
| 6 | Poly-Ethylene | Anhydrous | 320 | 30 | ±1% | >95% | 0% |
| 7 | Poly-Ethylene | Anhydrous | 380 | 30 | ±8% | >95% | 0% |
| 8 | Poly-Ethylene | Anhydrous | 320 | 180 | ±8% | >95% | 0% |

The experiments show that very high yields of carbon can be obtained at very low temperatures for different types of feeds. The experiments show that it is easier to convert bio-based materials (lignin, cellulose and sugars) than it is to convert polymers, but polymers converted well at somewhat higher temperatures. At the temperatures of 290° C. and higher the molten salt dehydrated and at temperatures of 320° C. and higher the molten salt was anhydrous. Carbohydrates have low H₂ yield because they produce mainly carbon and water. Good H₂ yields were obtained from carbonizing poly-ethylene. The experiments show the potential of the invention.

Further modifications in addition to those described above may be made to the structures and techniques described herein without departing from the spirit and scope of the invention. Accordingly, although specific embodiments have been described, these are examples only and are not limiting upon the scope of the invention.

1. A process to convert a carbon containing material comprising the following steps:
a. contacting and mixing the carbon containing material with a hydratable molten salt, wherein the carbon containing material is a waste material containing a hydrocarbon, preferably waste oil or refinery residues and/or a synthetic polymer, preferably a thermoplastic polymer and/or organic materials from bio-sources such as carbohydrates, proteins, cellulose, lignin, sugars,
b. converting the carbon containing material in the molten salt in a reactor under carbonisation conditions
i. at a temperature T1 between 200° C. and 500° C., preferably between 200° C. and 400° C., more preferably between 200° C. and 350° C. and
ii. preferably at a pressure below 50 bar, more preferably below 15 bar, even more preferably below 10 bar, most preferably below 1 bar,
iii. in absence of oxygen,
iv, wherein the hydratable molten salt is at least partially de-hydrated,
V. in presence of steam as inert gas,
vi. forming a conversion gas and a reaction mixture comprising non-volatile conversion products including carbon in the molten salt,
c. collecting conversion gas from an outlet on the reactor, optionally assisted by purging with steam, optionally cooling the conversion gas to condense the steam and recover dry conversion gas,
adding water or steam to the reaction mixture to cool the reaction mixture and re-hydrate the molten salt whereby phase separation occurs forming a non-volatile carbon phase and an at least partially re-hydrated molten salt phase,
e. separating the non-volatile carbon phase from the at least partially re-hydrated molten salt phase,
f. heating the obtained partially re-hydrated molten salt phase to form at least partially de-hydrated molten salt and steam, preferably in step a), in step b) or in a separate step,
g. using the at least partially de-hydrated molten salt phase in step a) or b)
h. preferably using the steam obtained in step f) in the process, preferably in step a) for purging oxygen from the reactor and the carbon containing material and/or in step d) for hydration of the molten salt.

2. (canceled)

3. The process according to claim 1, wherein the carbon containing material is a thermoplastic waste material (TPW) that comprises at least 50, more preferably a least 60, 70, 80 or even more preferably at least 90 wt. % thermoplastic polymer (TP) and preferably less than 40, more preferably less than 30 and even more preferably less than 20 wt. % of thermoset polymers and preferably also comprising less than 20 wt. % other waste feed components and wherein the thermoplastic polymer waste preferably comprises one or more thermoplastic polymers selected from the group consisting of Polypropylene, Polyethylene, Polyester, Polyvinylacetate, Polyvinylalcohol, Polyvinylchloride or mixtures, copolymers, blends or composites thereof, preferably thermoplastic polymers not comprising heteroatoms O, N or halogen, most preferably polyolefins.

4. The process according to claim 1, wherein the hydratable molten salt is a hydratable metal halide salt, wherein the metal preferably is Zinc, Aluminum, Antimony, Manganese, Calcium, Iron or Magnesium or combinations thereof, preferably ZnCl₂, FeCl₃, MgCl₂, MnCl₂, CaCl₂) or their bromine analogues or blends thereof, most preferably the molten salt comprises at least 70 wt. %, more preferably at least 80 wt % even more preferably at least 90 wt % and most preferably at least 95 wt % ZnCl₂ with the remainder of the molten salt preferably being one or more other metal halide salts, preferably AlCl₃, MnCl₂, SbCl₃ or FeCl₃.

5. The process according to claim 1, wherein
in step b) the molten salt comprises less than 20 wt. % hydrated water relative to the total weight of the molten salt and water, preferably less than 10 wt %, more preferably less than 5 wt. % or even more preferably less than 1 wt % and wherein
in step e) the re-hydrated molten salt comprises between 10 and 60 wt. % water, preferably between 15 and 50 wt. % and more preferably between 15 and 35 wt. % and wherein
the re-hydrated molten salt comprises at least 10 wt %, preferably at least 20 wt %, more preferably at least 30 wt % more water than the de-hydrated molten salt.

6. The process according to claim 1, wherein the cooling and separation steps d) and e) comprise one or more cooling and separation steps, wherein preferably:
the reaction mixture is cooled and hydrated to a temperature Tl below 200° C., preferably below 150° C., OR
wherein at least part of the reaction mixture is cooled to a temperature Th above 200° C., preferably above 250 or even 300° C., wherein optionally pressure is applied which pressure is preferably applied with steam, OR
wherein two or more subsequent cooling and separation steps are applied at different temperatures, preferably first a step iii) at high temperature Th and then a step ii) at low temperature Tl, wherein two or more different NVC fractions with different compositions are obtained.

7. The process according to claim 1, wherein the at least partially re-hydrated molten salt phase obtained in step e) is heated in step f) to a temperature above 250° C., preferably above 300° C., to de-hydrate the molten salt or wherein in step f) the at least partially re-hydrated molten salt is dehydrated by heating and applying vacuum, at a pressure below 100 Pa, more preferably below 0.1 Pa, even more preferably below 0.0001 Pa, and at a temperature preferably below 175° C., more preferably below 150° C., and above 100° C., preferably above 120° C. and wherein optionally a metal oxide is added before or during heating wherein the metal preferably is the same as the metal of the molten salt.

8. The process according to claim 1, wherein the at least partially re-hydrated molten salt phase obtained in step e) is recycled to the reactor in step b) and the heating of the re-hydrated molten salt of step f) to form de-hydrated molten salt is done in carbonisation reactor.

9. The process according to claim 1, wherein a solid carbon seed is added, preferably in step a, b) and/or d to enhance the conversion and/or separation of the carbon phase from the molten salt phase.

10. The process according to claim 1, comprising cooling the conversion gas collected in step c) to condense the steam to recover water and dry conversion gas, which dry conversion gas comprises less than 10 wt %, preferably less than 5 and even more preferably less than 3 wt % hydrocarbons having 2 or more carbon atoms.

11. The process according to claim 1, wherein the molten salt in step b) further comprises catalytic amounts of one or more dehydrogenation catalyst metals different from the metal in the molten salt, preferably chosen from the group of Ni, Fe, Zn or Cu, to enhance hydrogen yield in the process, preferably added in the form of a metal-organic complex like metal alkyls, metal-oxides or a metal-chloride complex, and wherein the catalytic amount is less than 10, preferably less than 5 or even less than 3 mole % of said metal relative to the moles of metal in the molten salt, wherein the one or more dehydrogenation catalyst are preferably chosen from the group of FeCl₃, NiCl₂, CuCl₂, Fe₂O₃, NiO and CuO and wherein the one or more dehydrogenation catalyst metals are optionally supported on a solid carbon source.

12. The process according to claim 1, wherein one or more reactants are added to the molten salt in step a) or b) to react with the hetero-atom containing impurities present or formed during carbonisation conversion step b), preferably one or more impurities selected from the group consisting of halogens, CO₂, SOx and NOx, wherein the reactant forms a precipitate which can be separated, which reactant is a metal compound, more preferably metal oxide or metal hydroxide, even more preferably zinc oxide, magnesium oxide, iron oxide or nickel oxide, to form one or more of metal-halogenides, metal-carbonates, metal-sulfates, or metal-nitrates, or wherein preferably the heteroatom is a halogen which is converted with a metal oxide, preferably Zinc-oxide, to convert to a metal halide, preferably Zinc-halide, which is part of the molten salt used in the process and does not need to be separated.

13. The process according to claim 1, wherein the at least partially re-hydrated molten salt phase obtained in step e) is used in a separate step e.1) before being de-hydrated and used in step a) or b) for the separation or carbonization of biological organic waste, preferably a biological organic waste comprising cellulose, hemicellulose and/or lignin, at a temperature below 300° C., preferably below 250° C.

14. The process according to claim 1, wherein the non-volatile carbon phase obtained in step e) is washed with water at a temperature below 100° C. to dissolve and remove residue of the molten salt and preferably recycling the wash water to step d).

15. The process according to claim 1, wherein the carbon containing feed is converted in a continuous process comprising continuously:
1) providing the carbon containing feed and hydratable molten salt and at least partly converting the carbon containing feed in the molten salt in a carbonisation reactor to form conversion gas and carbon,
2) taking the conversion gas from the carbonisation reactor to a condenser to condense steam and separate dry conversion gas and transferring part of the molten salt containing the carbon to a separation reactor,
3) adding water or steam to the molten salt containing the carbon in the separation reactor to cool and re-hydrate the molten salt to form a phase separated non-volatile carbon phase and an at least partially re-hydrated molten salt phase,
4) separating and transferring the at least partially re-hydrated molten salt phase out of the separation reactor,
5) optionally using the at least partially re-hydrated molten salt phase from the separation reactor for the separation or carbonization of biological organic waste and separating the at least partially re-hydrated molten salt after use in this step,
6) transferring the at least partially re-hydrated molten salt to a heating reactor and heating the at least partially re-hydrated molten salt phase to de-hydrate to at least partially de-hydrated molten salt and steam and recycling the at least partially de-hydrated molten salt back to the carbonisation reactor OR transferring the at least partially re-hydrated molten salt directly to the carbonisation reactor and heating the at least partially re-hydrated molten salt phase in the carbonisation reactor to de-hydrate to at least partially de-hydrated molten salt and steam,
7) wherein optionally impurities are removed from the at least partially de-hydrated molten salt or the at least partially re-hydrated molten salt prior to recycling back to the carbonisation reactor,
8) removing the non-volatile carbon phase from the separation reactor continuously or semi-continuously, optionally followed by washing the non-volatile carbon phase with water to remove residue of the molten salt, optionally followed by recycling part of the non-volatile carbon phase, or of solid carbon isolated from the separated non-volatile carbon phase, back to the carbonisation reactor as seed to enhance the conversion and/or separation of the non-volatile carbon.

16. A solid carbon phase obtainable by the process according to claim 1, wherein preferably the carbonisation temperature T1 is between 200 and 350° C.

17. A process for the production of active carbon, soil enhancement compounds, electronic materials, carbon fiber, carbon nano fiber or a carbon nanofiber precursor, graphene or graphene precursor from the solid carbon phase according to claim 16.
